(19) United States
(12) Patent Application Publication
(10) Pub. No.: US 2002/0062752 A1
(43) Pub. Date: May 30, 2002

(54) Toy stamper

(76) Inventor: Timothy Clarke, Ridgefield, CT (US)

Correspondence Address: Robert M. Haroun, SOFER & HAROUN, LLP, Suite 1921, 342 Madison Avenue, New York, NY, 10173, US

(21) Appl. No.: 09/727,359

(22) Filed: Nov. 29, 2000

(51) Int. Cl. B41F 13/10

(52) U.S. Cl. 101/375

(57) ABSTRACT

The present invention provides for a toy stamper having a body portion. The body portion of the toy stamper has a first attachment point where a first wheel member is attached. The wheel is provided with a stamp ring disposed about the circumference wheel, and is configured to stamp a pattern onto a substrate when the stamp ring is inked and moved across the substrate. The stamp ring is advantageously provided with a second wheel attached at the first attachment point such a that a wheel pair is formed. The wheel pair, with both wheels having a stamp ring disposed thereon, produces tracks of various design, such as wheel treads, when the wheel pair is inked and moved across a substrate.

### FIELD OF THE INVENTION

The present invention relates to a toy for printing patterns on a surface. More particularly, the present invention relates to a stamp for printing patterned markings by way of a stamp ring affixed to a miniaturized toy.

### BACKGROUND

There are many types of stamping devices available on the market for printing messages or designs. Standard stamping devices include date stampers, fixed message stamps, stamps with inter-changeable letters or words, designs such as stars or other pictures, and so on. These stamps are generally used by inking the head of the stamp and placing the head against the substrate to be printed on.

Another means of producing a pattern on a substrate includes a painter roller with a raised portion and a lower portion. The different heights of the roller surface produce a continuous pattern which can be applied to a substrate with a rolling motion. When the roller is rolled through a paint trough the raised portions of the roller are coated while the lower portion is left dry. The roller is then drawn across the substrate applying a continuous painted pattern.

Additionally, there are several toys or recreational devices such as bicycles and skateboards which have been miniaturized for marketing to children and teenagers. These toys display some of the necessary features of the toy, however, they do not necessarily contain all of the components of an operational full-sized toy. These miniaturized toys have been sold for use in such items as key chain ornaments, toys, and for other play related purposes.

A particular example of a miniaturized skateboard may include the Tech Deck line as manufacture by X-Concepts, LLC. This miniaturized skateboard provides a replica skateboard approximately 3″-4″ in overall length. The wheels are inter-changeable with different colors, achieved by loosening a screw on the tracks and removing the one set of wheels and replacing it with another set.

There is however, no device in the prior art which combines a miniature play toy such as skate board or bicycle with a rolling stamping device. Although the prior art may contain stamps which maintain the picture of a skateboard, there is no device in the prior art which uses a functional aspect of a miniature toy, namely the wheel portions, to function as a rolling stamping device, such that when the wheels of the miniaturized skateboard are inked, the moving of the skateboard across a substrate will produce a stamped pattern. The present invention looks to provide such a device.

### SUMMARY OF THE INVENTION

In a preferred embodiment of the present invention, a toy stamper is provided comprising a body portion having a first attachment point coupling at least one wheel member to the body portion and a stamp ring disposed on the wheel member where the stamp ring is configured to stamp a pattern onto a substrate when the toy stamper is inked and moved across a substrate.

In one embodiment of the present invention, the wheel members are removably attached to the attachment point allowing for easy attachment and removal. Additionally, the wheel members may maintain a stamp ring channel configured to provide a support means for a stamp ring to prevent it from sliding off of the wheel member during operation. This ring channel is disposed between the first and second wheel member flanges and is configured to support the stamp ring. This stamp ring is preferably constructed of rubber or some other suitable polymer.

In one embodiment of the present invention, the toy stamper is configured to support a plurality of wheel members with a plurality of stamp rings thus allowing the pattern transferred to the substrate to contain elements of at least two of stamp rings. A cover is provided for the stamp rings for storage.

In another embodiment of the present invention, a skateboard stamper is provided with a body portion, two attachment points, four wheel members and a stamp ring disposed on at least one of those wheel members configured to stamp a pattern onto a substrate when the skateboard stamper is inked and moved across the substrate.

In a further embodiment of the present invention, the body portion of the skateboard stamper is a deck provided with two raised portions disposed at either end of the longitudinal axis of the deck configured to provide a user with more control over the stamping procedure.

In an additional embodiment of the present invention the wheel support members are disposed at opposite ends of the under side of said deck configured to removably attach the wheel member pairs to the skateboard stamper.

In another embodiment of the present invention a plurality of the wheel members are provided with stamp rings, such that the pattern transferred to the substrate contains elements of at least two stamp rings. The wheel members have a stamp ring channel disposed on at least one of the wheel members which is configured to provide a support means for the stamp ring to prevent it from sliding off of the wheel member. This stamp ring channel is formed by a first and second wheel member flanges, disposed between them.

### BRIEF DESCRIPTION OF THE DRAWINGS

FIG. 1, is a side elevation view of a skateboard stamper along a vertical axis, in accordance with one embodiment of the present invention;

FIG. 2, is a front elevation view of a skateboard stamper as shown in FIG. 1, in accordance with one embodiment of the present invention;

FIG. 3 is a underside view of a skateboard stamper as shown in FIG. 1, in accordance with one embodiment of the present invention;

FIG. 4a, is a close up front elevation view of a wheel member of a skateboard stamper, as shown in FIG. 1, without a stamp ring, in accordance with one embodiment of the present invention;

FIG. 4b, is a close up front elevation view of a wheel member of a skateboard stamper with a stamp ring, in accordance with one embodiment of the present invention;

FIG. 5a-5n are representations of patterns embedded on the stamp rings, in accordance with one embodiment of the present invention; and

FIG. 6, is an overhead view of a skateboard stamper positioned on a substrate and moved in left direction thus providing a printed pattern, in accordance with one embodiment of the present invention.

### DETAILED DESCRIPTION OF THE PREFERRED EMBODIMENTS

General

In a preferred embodiment of the present invention, a toy stamper is provided such that at least one of the wheels is provided with a stamp ring which is embossed with a pattern such that when the stamp ring is inked, the toy can be moved across a substrate to produce a printed pattern on the substrate. The toy stamper can be made in the likeness of any wheeled toy that is miniaturized provided that the toy has at least one wheeled or circularly movable part disposed thereon. For the purposes of this application, a miniaturized skateboard will be used to illustrate the salient features of this invention, however, any wheeled miniaturized toy such as bicycles, tricycles, motorized or non-motorized vehicles, recreational vehicles, ATVs, ATCs, cars or trucks, wherein a stamp ring may be attached to one of the wheels is within the contemplation of this invention.

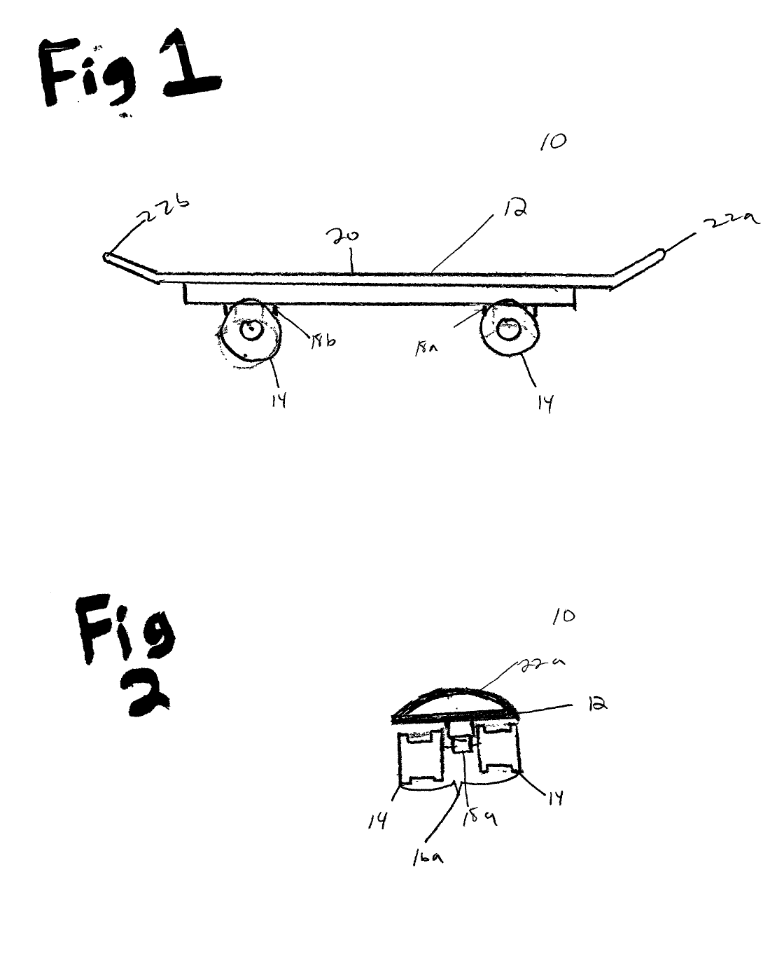

In the present invention, and as illustrated in FIGS. 1 and 2, a miniaturized skateboard 10, is comprised of a deck 12 representing the body portion, four wheel members 14 paired into two wheel pairs 16a and 16b (illustrated in more detail in FIG. 3), and attachment points 18a and 18b. Deck 12 of skateboard 10 is comprised of a substantially flat center region 20 and two raised end portions 22a and 22b located at the opposite ends of the longitudinal axis of skateboard 10. Raised portions 22a and 22b add to user control during the stamping motions. On the under side of deck 12, attachment points 18a and 18b are disposed on opposite ends of deck 12. Attached to attachment points 18a and 18b are wheel pairs 16a and 16b. Wheel pairs 16a and 16b are each formed from two connected wheel members 14 and a connecting axle. As illustrated in FIG. 3, wheel pairs 16a and 16b are friction fitted or connected to wheel support means 16a and 16b via the connecting axle which couples to attachment points 18a and 18b by clipping into an axle grove 24.

In a preferred embodiment of the present invention, wheel pairs 16a and 16b are configured to be removably connected to attachment points 18a and 18b. This configuration allows for different wheel members 14, grouped as wheel pairs 16a and 16b, to be readily interchangeable allowing for greater versatility in creating stamping patterns. Although the general construction of the toy stamper has been described in the embodiments of skateboard 10, any similar miniaturized wheeled stamping toy which maintains a similar construction and wheel attachment construction is within the contemplation of this invention.

Stamp Ring

In a preferred embodiment of the present invention, at least one of wheel members 14 is provided with a stamp ring 26 preferably constructed of rubber or some form of polymer well suited for use in stamping. Stamp ring 26 is fitted around the outside circumference of wheel member 14 such that stamp ring 26 will continuously contact a substrate when wheel member 14 is rolled.

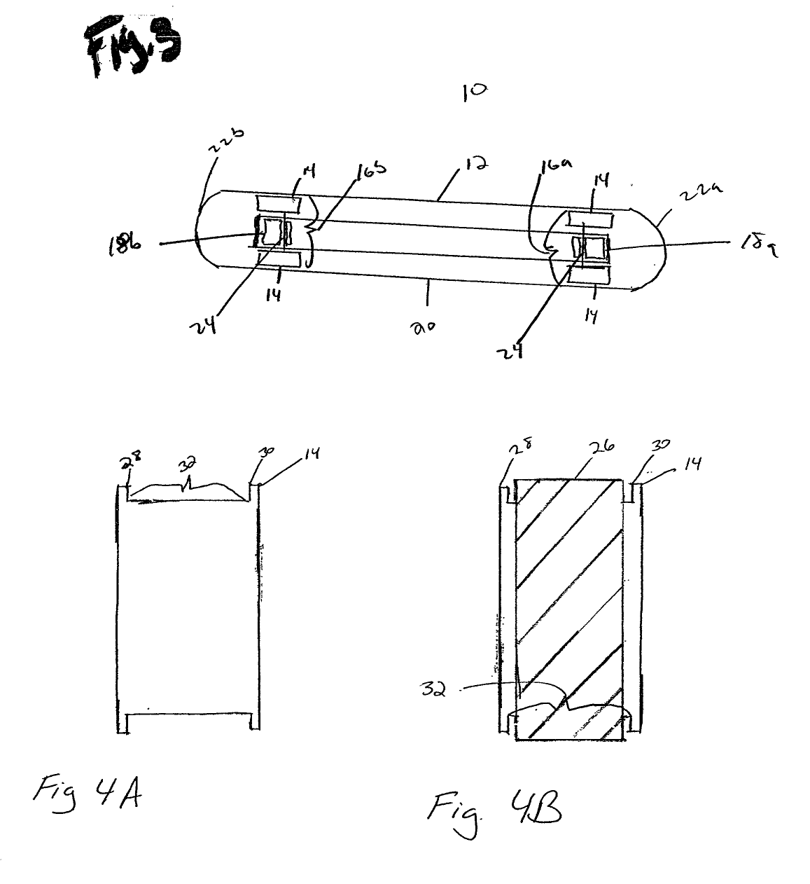

In a preferred embodiment of the present invention, a variation of wheel member 14 is provided to better support stamp ring 26 so as to prevent stamp ring 26 from slipping off of wheel member 14 during the stamping process. In this embodiment as illustrated in FIGS. 4a and 4b, wheel member 14 further comprised of a first wheel member flange 28 and a second wheel member flange 30. First and second wheel member flanges 28, 30 are disposed at the edges of wheel member 14 vertical axis and are relatively narrow with respect to the horizontal axis of wheel member 14, as illustrated in FIG. 4a. Because first and second wheel member flanges 28, 30 have a radius just slightly larger than the radius of the remaining center cylinder portion of wheel member 14 they form a stamp ring channel 32. Stamp ring channel 32 is comprised of the majority of the center cylindrical portion of wheel member 14 and having boundaries on either side formed by first and second wheel member flanges 28, 30.

In the present invention stamp ring 26 is disposed within stamp ring channel 32, preventing stamp ring 26 from sliding off of wheel member 14 during operation. The depth of stamp ring channel 32 is preferably just slightly shallower than the thickness of stamp ring 26, such that stamp ring 26 protrudes just enough to provide ample stamping surface. However, the depth of stamp ring channel 32 does not need to be of any particular depth. Different stamp ring 26 designs may allow for different types of thicknesses of raised surfaces. Any depth of stamp ring channel 32 that is adequate to properly function to secure stamp ring 26 to wheel member 14 is within the contemplation of this invention.

Sample Patterns

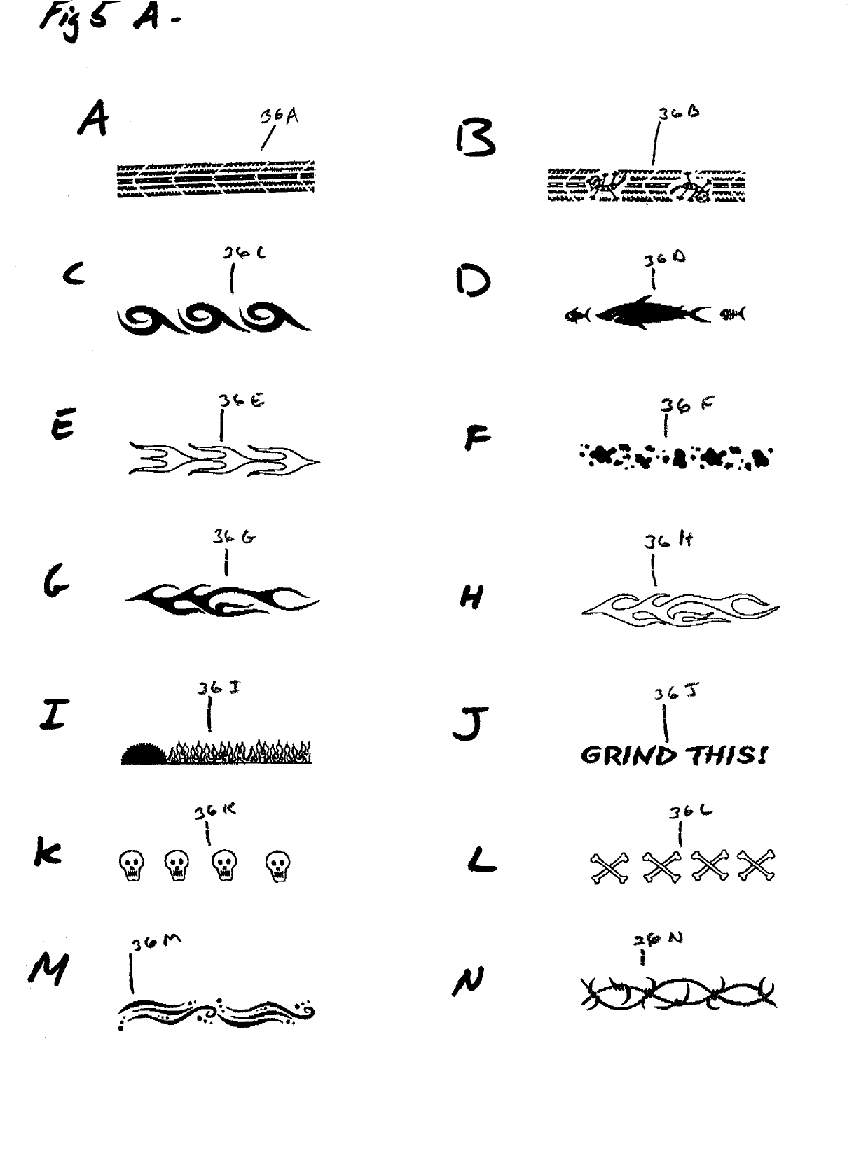

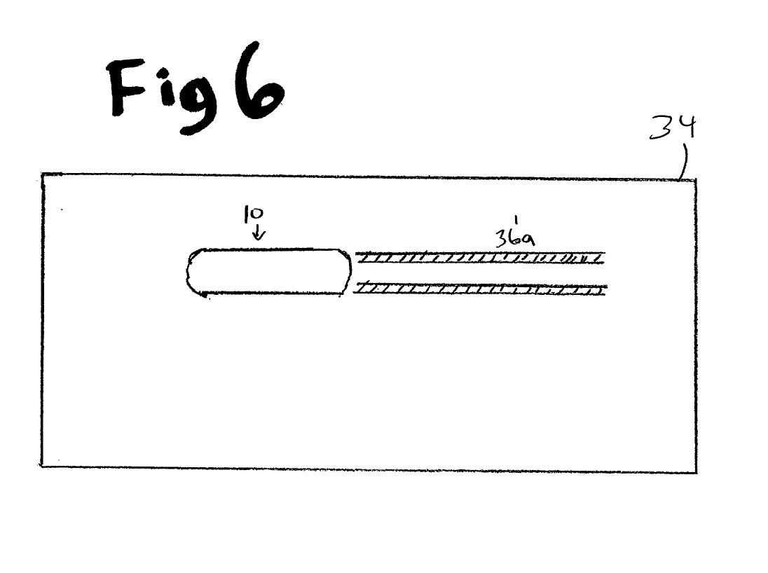

As illustrated in FIGS. 5a-5n, sample patterns 36a through 36n show the various marking that can be applied to a substrate 34. Pattern 36a is a tire tread design. Pattern 36b is a tire tread with roadkill design. Pattern 36c is a swirl design. Pattern 36d is a fish design. Pattern 36e is a three-prong design. Pattern 36f is a spotted design. Pattern 36g is a solid flame design. Pattern 36h is a solid flame design. Pattern 36i is a circular blade and flame design. Pattern 36j is a “grind this” text message. Pattern 36k is a skull design. Pattern 361 is a crossbones design. Pattern 36m is a wavy line design. Pattern 36n is a barbed wire design.

Patterns 36a through 36n are samples of some of the patterns used in one embodiment of the present invention, however any pattern that can be readily embedded into ring stamp 26 is within the contemplation of the present invention. It should be noted that design 36a through 36n represent patter 36 for one stamp ring 26 as used on one wheel member 14, however when used stamp rings 26 are used together on both wheel members 14 of a wheel pair 16a, any combination of patterns 36 can be used. For example, matching patterns 36a can be used to create matching tire tread marks. In another example, one wheel member 14 of wheel pair 16a has a stamp ring 26 that bears the skull pattern 36k and the other wheel member 14 of wheel pair 16a has a stamp ring 26 that bears the crossbones pattern 36l, such that when the skateboard stamper 10 is used it will produce a skull and crossbones design on substrate 34. Any pattern 36 or combination of patterns 36 are within the contemplation of the present indentation.

Stamping

In a preferred embodiment of the present invention, skateboard 10 is used to stamp patterns 36 onto a substrate 34. Materials used for substrate 34 include but are not limited to paper, cardboard, wood stickers—applied to skateboard ramps and obstacles or other flat marking surfaces that are constructed of material conducive for marking. During the operation of skateboard 10, wheel members 14 of skateboard 10 are inked or marked with a stamping medium to be applied to substrate 34. As noted earlier, at least one of wheel members 14 must have a stamp ring 14 with a pattern 36 set thereon, however, it is within the contemplation of the present invention that skateboard 10 can have any number of wheel members 14 (between one and four) with a stamp ring 26.

When skateboard 10 is prepared for stamping, the appropriate wheel members 14 are inked or coated with the medium to be applied to substrate 34. Then, skateboard 10 is placed in the desired starting position and moved across substrate 34 for the desired distance. This results in stamp ring or rings 14 transferring a continuous pattern 36 onto substrate 34. As illustrated in FIG. 6, pattern 36′ as it appears on substrate 34 is drawn in a substantially linear manner. This pattern 36′ is the result of two stamp rings 26, affixed to opposing wheel members 14 of one of wheel pairs 16a or 16b which gives the impression of tracks.

Although pattern 36′ utilizes two stamp rings 26, any number of stamp rings used to produce a pattern 36′ is within the contemplation of the present invention. For example, if all four wheel members 14 of skateboard 10 are used and the front wheel member pair 16a is offset relative to the rear wheel pair 16b, pattern 36′ might display four separate lines. Alternatively, it is also possible that a wheel pair 16a and wheel pair 16b may have two separate stamp rings 26 affixed such that when skateboard 10 is moved across substrate 34 stamp ring 26 on wheel pair 16a produces a first mark and stamp ring 26 on wheel pair 16b produces a second mark different from the first mark, such that the combination of the two marks produces a combined pattern 36′. Many variations are available creating a variety of patterns 36′ from a pattern 36 embedded on stamp ring 26, as such, all variations of pattern 36′ that are attainable using one or more stamp rings 26 as affixed to wheel members 14 is within the contemplation of this invention.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

1. A toy stamper comprising:
a body portion having a first attachment point; and
a first wheel member coupled to said body portion at said first attachment point, said first wheel member having a circumference, wherein said circumference of said first wheel member is provided with a stamp ring, said stamp ring configured to stamp a pattern onto a substrate when said stamp ring of said toy stamper is inked and moved across said substrate.

2. The toy stamper as claimed in claim 1, further comprising a wheel member pair, said wheel member pair having an axle, a first wheel and a second wheel, said first and second wheels connected to said axle, said axle coupled to said first attachment point of said body portion of said toy stamper.

3. The toy stamper as claimed in claim 1, further comprising, a second attachment point on said body portion of said toy stamper.

4. The toy stamper as claimed in claim 3, further comprising, a second wheel member pair, said second wheel member pair having an axle, a first wheel and a second wheel, said first and second wheels connected to said axle, said axle coupled to said second attachment point of said body portion of said toy stamper so that said toy stamper is supported by said first and second wheel member pairs.

5. The toy stamper as claimed in claim 1, further comprising a second stamp ring disposed on the circumference of said second wheel of said first wheel member pair so that when said first and second stamp rings on said first and second wheels of said first wheel member pair are inked and moved across said substrate, a track shaped pattern is produced on said substrate.

6. The toy stamper as claimed in claim 1, wherein said first wheel member pair is removably attached to said first attachment point of said body portion.

7. The toy stamper as claimed in claim 2, wherein said first wheel of said first wheel member pair is provided with a circumference region, said circumference region having first and second spaced apart flanges forming a stamp ring channel, so that when said stamp ring is received in said stamp ring channel, said spaced apart flanges prevent said stamp ring from being sliding off said first wheel.

8. The toy stamper as claimed in claim 1, wherein said stamp ring is fabricated of a rubber material.

9. The toy stamper as claimed in claim 1, further comprising a stamp wheel cover for covering said stamp ring.

10. A skateboard stamper comprising:
a body portion having first and second attachment points;
first and second wheel member pairs each said pair comprised of two wheel members coupled by an axle; and
at least one of said wheel members having a circumference, wherein said circumference of said wheel member is provided with a stamp ring, said stamp ring configured to stamp a pattern onto a substrate when said stamp ring of said skateboard stamper is inked and moved across said substrate.

11. A skateboard stamper as claimed in claim 10, wherein both of said wheel members of either one of said first and second wheel member pairs, are provided with a stamp ring, said stamp rings configured to stamp a track pattern onto a substrate when said stamp rings disposed on said wheel member pair of said skateboard stamper are inked and moved across said substrate.

12. A skateboard stamper as claimed in claim 10, wherein said wheel members of said skate board stamper are provided with a circumference region, said circumference region having first and second spaced apart flanges forming a stamp ring channel, so that when said stamp ring is received in said stamp ring channel, said spaced apart flanges prevent said stamp ring from being sliding off said first wheel.

13. A skateboard stamper as claimed in claim 10, wherein said wheel member pairs are removably attached to said attachment points of said body portion.

14. A skateboard stamper as claimed in claim 10, wherein said body portion of said skateboard stamper is in the shape of a skateboard deck having raised front and rear raised portions, said raised portions configured to provide a user with more control over the stamping procedure.

15. A skateboard stamper as claimed in claim 10, further comprising a plurality of stamp wheel covers, said plurality of stamp wheel covers being equal to the number of wheel members with a stamp ring disposed thereon.
